(19) United States
(12) Patent Application Publication
(10) Pub. No.: US 2003/0062026 A1
(43) Pub. Date: Apr. 3, 2003

(54) Common rail system

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/129,520

(22) PCT Filed: Aug. 29, 2001
(86) PCT No.: PCT/DE01/03303

(51) Int. Cl. F02M 1/00; F16K 31/12

(52) U.S. Cl. 123/446; 251/57; 123/459

(57) ABSTRACT

A valve for triggering a fluid is proposed, having an actuator unit (7) for actuating an axially displaceable valve member (6), with which a valve closing member (15) is associated, which for opening and closing the valve (1) cooperates with a valve seat (23) and which separates a high-pressure region (3) from the valve (1). In the high-pressure region (3), the fluid to be triggered is at an operating pressure (p_R). This operating pressure (p_R) and an overpressure that may occur in some circumstances is recorded, because of the provision that the actuator unit (7) is embodied as a force-measuring sensor. In particular, this valve (1) serves as a pressure-limiting valve in a common rail system (Drawing).

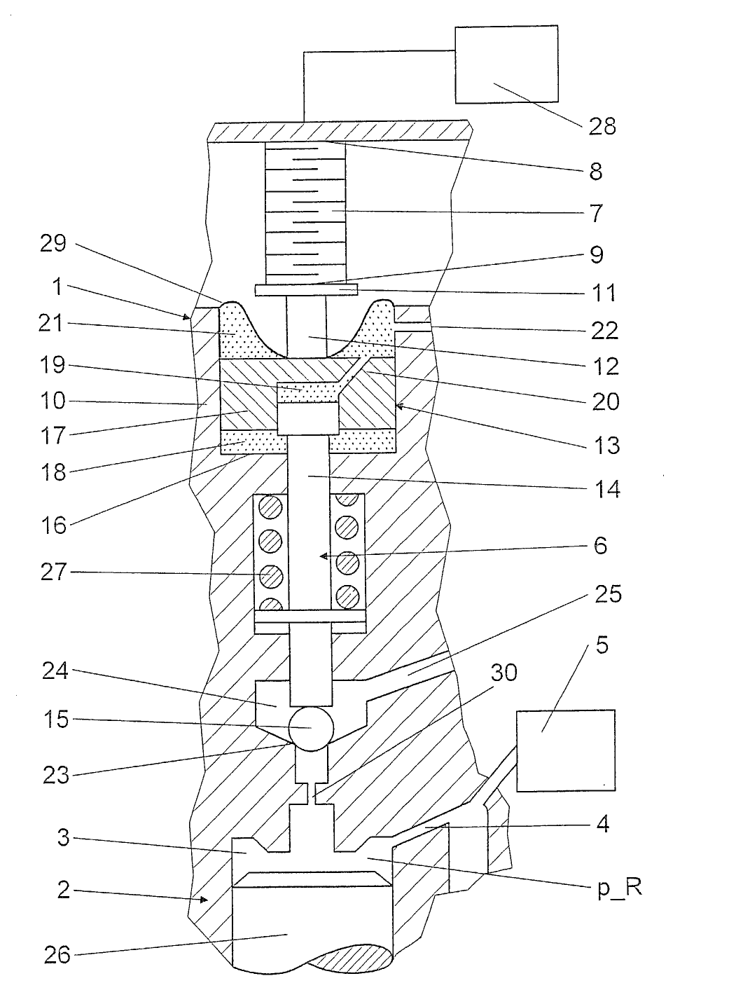

### PRIOR ART

The invention is based on a common rail system as generically defined by the preamble to claim 1, and in particular a valve for triggering a fluid, of the type defined in further detail in claim 3.

Such valves for triggering a fluid, in which as a rule a valve closing member separates a low-pressure region inside the valve from a high-pressure region outside it, are known in the most various versions in the industry, among others in fuel injectors, such as common rail injectors, or in pumps in the automotive field.

For instance, from European Patent Disclosure EP 0 477 400 A1, a valve of this generic type is known, which is actuatable via a special piezoelectric actuator. Moreover, the valve described in this reference has an arrangement for a travel transformer, acting in the stroke direction, of the piezoelectric actuator; its deflection is transmitted via a hydraulic chamber. This hydraulic chamber serves as a boosting- and tolerance-compensation element.

The boosting ratio is determined by way of the different diameters of two pistons, between which the hydraulic chamber is disposed. Via the working volume of the hydraulic chamber, settling effects that may occur under some circumstances, as well as tolerances, which occur for instance from different coefficients of temperature expansion of the materials that are used in the valve, can be compensated for.

From the prior art, common rail systems with magnet valves are also known, in which a spring presses a suitable valve closing member against a valve seat for sealing purposes.

In conventional common rail systems, in which the injection pressure is generated independently of the engine rpm and of the injection quantity and is kept in readiness in a common fuel reservoir (common rail) for injection via valve-controlled injectors, pressure-limiting valves are used to secure against overpressure; as a rule, they are disposed in the region of the fuel reservoir that is common to all the injection valves.

Such a pressure-limiting valve limits the pressure in the fuel or pressure reservoir by uncovering an outlet opening for the fuel if the load becomes too high. At a normal operating pressure of up to 1350 bar in the pressure reservoir, for instance, it can briefly allow a maximum pressure of up to 1500 bar.

The pressure-limiting valves known in the industry are mechanically operating components with a housing with a male thread for being screwed onto the rail, a connection to a return line to a fuel container, a movable piston, and a spring. On the connection side to the rail, the housing has a bore, which is closed by a conical end of the piston at the sealing seat in the housing interior.

At normal operating pressure of the fuel, the spring presses the piston tightly into its sealing seat, so that the pressure reservoir remains closed on the connection side, that is, the side to which the pressure-limiting valve is connected. Not until the maximum operating or injection pressure is exceeded is the piston pressed against the spring by the overpressure prevailing in the pressure reservoir, allowing the fuel that is at high pressure to escape. The escaping fuel is then carried via conduits into a cylindrical bore of the piston and returned to the fuel container via a collecting line.

### ADVANTAGES OF THE INVENTION

The common rail system of the invention having the characteristics of claim 1 advantageously requires no separate overpressure valve, known from the prior art, on the common rail pressure reservoir, since the function of such a valve is taken over by the already existing control valves by means of which the injection behavior in the injection devices is controlled.

It is especially advantageous if a valve according to the invention for controlling a fluid and having the characteristics of claim 3 is employed. Such a valve, which it is understood can also be used in other fields, offers the advantage that the prevailing pressure is sensed via a possibly already present actuator unit, and the pressure-limiting function can be achieved essentially via simple software.

Thus not only do pressure-limiting valves, as additional components, become superfluous, but furthermore there is no significant additional mechanical effort or expense for the valves, so that a considerable cost saving can be attained as a result.

Further advantages and advantageous features of the subject of the invention can be learned from the description, drawing and claims.

### DRAWING

One exemplary embodiment of the valve of the invention for triggering a fluid is shown in the drawing and will be explained in further detail in the ensuing description.

The sole drawing FIG. is a schematic, fragmentary view of one exemplary embodiment of the invention for an injection device of a common rail system, in longitudinal section.

### DESCRIPTION OF THE EXEMPLARY EMBODIMENT

The exemplary embodiment shown in the drawing illustrates a use of the valve 1 of the invention in a common rail injector or injection device 2 for injecting preferably Diesel fuel for internal combustion engines of motor vehicles. In the present version, the fuel injection is effected by way of the pressure level in a valve control chamber 3 that communicates with a high-pressure supply 4. A high pressure or injection pressure p_R that defines the high-pressure region prevails in this valve control chamber 3. The high-pressure supply 4 connects the valve control chamber 3 to a common rail pressure reservoir 5, in which once again the fuel is at high pressure p_R.

For establishing an injection onset, injection duration and injection quantity by way of certain force conditions in the injection device 2, a valve member 6 in the valve 1 is triggered via an actuator unit embodied as a piezoelectric actuator 7, which is disposed on the side of the valve member 6 remote from the valve control chamber 3 and from the combustion chamber.

The piezoelectric actuator 7 is made up in the usual way of multiple layers, and on its side toward the valve member 6 it has an actuator head 9, while on its side remote from the valve member 7 it has an actuator foot 8, which is braced on a wall of a valve body 9 of the valve 1. Via a bearing plate 11, a first piston 12 of a hydraulic booster 13 of the valve member 6 is adjacent. The valve member 6 is disposed axially displaceably in a suitable longitudinal bore of the valve body 10 and has a second piston 14, which actuates a valve closing member 15.

Within the hydraulic booster 13, the first piston 12 and second piston 14 are embodied such that they are disposed axially displaceably in a chamber 16 of the hydraulic booster 13 in the valve body 10; the second piston 14 is in turn guided in a cufflike end piece 17 of the first piston 12.

The first piston 12 and second piston 14, together with the valve body 9, adjoin a first hydraulic chamber 18. Between the side of the second piston 14 remote from the first hydraulic chamber 18 and the first piston 12, a second hydraulic chamber 19 is embodied in the recess intended for guiding the second piston 14 in the first piston 12.

It should be noted that as a result of the special disposition of the hydraulic chambers 18 and 19, a reversal of motion between two pistons 12 and 14 is brought about. If the first piston 12 is forced downward as a consequence of a deflection of the piezoelectric actuator 7, this simultaneously causes a stroke motion of the second piston 14 in the opposite direction. This second piston 14 positively displaces the operating fluid located in the second hydraulic chamber 19 into a compensation chamber 21 via a compensation conduit 20. The compensation chamber 21 communicates with a leakage compensation conduit 22, for the sake of diverting the operating fluid, and is sealed off from the piezoelectric actuator 7 by a diaphragm 29.

In other words, the pistons 12 and 14 in the hydraulic booster 13 are coupled to one another in such a way that the deflection of the piezoelectric actuator 7 is transmitted, because the second piston 14 is raised by a certain travel distance, as a function of the boosting ratio of the piston diameters.

On the end toward the valve control chamber 3 of the valve member 6, the ball-like valve closing member 15 cooperates with a valve seat 23 embodied on the valve body 10; the valve closing member 15 separates a low-pressure region 24, with a low fluid pressure prevailing in it, from an outlet throttle 30 and the valve control chamber 3, which can be acted upon by the high or injection pressure p_R of the fluid.

From the low-pressure region 24, a leakage compensation conduit 25 branches off. The valve control chamber 3 of the injection device 2 is in only fragmentary form in the drawing. Disposed in it is a movable nozzle needle 26, which closes and opens an injection opening into a combustion chamber of an engine. By its axial motion, the injection behavior of the injection devices 2 is controlled in a manner known per se; the fuel in the valve control chamber 3 is delivered via the high-pressure supply 4 from the pressure reservoir 5 that is common to a plurality of injection devices 2, and the valve control chamber 3 is relieved for injection via the outlet throttle 30 and the valve 1 of the invention.

Between the hydraulic booster 13 and the valve closing member 15, there is a sealing spring 27, which surrounds the second piston 14 and is braced in the valve body 10 in such a way that by means of the spring force of the sealing spring 27, the second piston 14 is pressed downward, so that in the state of repose of the valve 1, the valve closing member 15 comes to rest sealingly against the valve seat 23.

The actuator unit 7, embodied here with piezoceramic, serves according to the invention not only as a stroke device but also as a force sensor, because the force changes acting on the piezoelectric unit are recorded as voltage changes. To that end, the piezoelectric actuator 7 is in communication with a control unit 28 via a single line, which functions as both a sensor line and control line.

This control unit 28 serves both as a measurement pickup, when the piezoelectric actuator 7 functions as a force-measuring sensor, and simultaneously as a triggering unit, when the piezoelectric actuator 7 is to be deflected. Within the control unit 28, these functions can be accomplished jointly via a suitable electronic circuit or suitable software.

The valve 1 of the invention takes on the function of a pressure-limiting valve for an overpressure that may occur in the high-pressure region 3 and that is above the injection pressure p_R. The diameter of the valve seat 23, for a fixed spring force of the sealing spring 27, determines the sealing force. If this sealing force fails to be exceeded, the valve 1 opens on its own, without triggering by the piezoelectric actuator 7, if the contrary force, resulting from the overpressure in the high-pressure region 3, exceeds the sealing force. In that case, by means of the stroke of the second piston 14 and of the hydraulic booster 13, a force is transmitted to the piezoelectric actuator 7, which measures this force and transmits it to the control unit 28. Thus the control unit 28 is capable of detecting the presence of a malfunction in the high-pressure region 3.

By a then-ensuing purposeful deflection of the piezoelectric actuator 7, the stroke of the second piston 14 and thus the valve closing member 15 can then be opened purposefully so that the overpressure that prevails in the high-pressure region 3 can be reduced again via the leakage compensation conduit 25.

The opening for the sake of reducing the overpressure is clocked so briefly that no triggering of the nozzle needle 26 itself can occur. In other words, the opening of the valve 1 takes place in such short periods of time that because of the inertia of the nozzle needle 26, the nozzle needle remains in its closing position, with the effect that the injection device 2 does not open, and no injection of fuel occurs.

It is also understood that the invention can be employed not only in the common rail systems described here as a preferred application, but can also be realized in general in fuel injection valves or in other fields, such as pumps, where an abrupt reduction in a briefly occurring overpressure has to be assured.

1. A common rail system, having a common rail pressure reservoir (5) and a plurality of injection devices, each triggerable via a respective control valve (1), characterized in that at least one of the control valves (1) is simultaneously embodied as a pressure-limiting valve for the common rail pressure reservoir (5).

2. The common rail system of claim 1, characterized in that the control valve (1) is triggerable by a control unit (28) in such a way that if an overpressure is detected in the common rail pressure reservoir (5), it remains open until such time as the overpressure has been reduced via the control valve (1) without a nozzle needle (26) of the injection device (2) being triggered.

3. A valve, in particular as a control valve in a common rail system of claim 1 or 2, for triggering a fluid, having an actuator unit (7) for actuating an axially displaceable valve member (6), with which a valve closing member (15) is associated that for opening and closing the valve (1) cooperates with a valve seat (23) and that separates a high-pressure region (3) from the valve (1), in which the fluid to be triggered is at a high pressure (p_R), characterized in that for measuring the prevailing high pressure (p_R), the actuator unit (7) is simultaneously embodied as a force-measuring sensor and is triggerable as a function of the detected force acting on it.

4. The valve of claim 3, characterized in that the actuator unit (7) is embodied as a piezoelectric unit.

5. The valve of claim 3 or 4, characterized in that the valve member (6) is coupled with a sealing spring (27), which presses the valve closing member (15) at a certain sealing force against the valve seat (23).

6. The valve of one of claims 3-5, characterized in that the valve closing member (15) is disposed in a low-pressure region (24), in which the fluid is at a low pressure when the valve (1) is closed.

7. The valve of claim 6, characterized in that the low-pressure region (24) communicates with a leakage compensation conduit (25).

8. The valve of one of claims 3-7, characterized in that the valve member (6) has a hydraulic booster (13).

9. The valve of claim 8, characterized in that the hydraulic booster (13) is embodied such that the valve member (6) is displaceable counter to a deflection direction of the piezoelectric unit (7).

10. The valve of claim 9, characterized in that the hydraulic booster (13) has a first piston (12), in which a second piston (14) of the valve member (6) is guided in such a way that one hydraulic chamber (18) and (19), respectively, is disposed on either side of the second piston (14).
